(19) United States
(12) Patent Application Publication
(10) Pub. No.: US 2025/0095144 A1
(43) Pub. Date: Mar. 20, 2025

(54) MACHINE-LEARNING BASED DETERMINATION OF VITAL SIGNS AND A PHYSIOLOGICAL STATE OF AN EXISTING OR POTENTIAL POLICY HOLDER FOR INSURANCE UNDERWRITING

(71) Applicant: BRIGHTERMD LLC, Plano, TX (US)

(72) Inventor: Jesse Ohayon, Plano, TX (US)

(21) Appl. No.: 18/471,247

(22) Filed: Sep. 20, 2023

(51) Int. Cl. G06T 7/00; G06Q 40/08

(52) U.S. Cl. CPC G06T 7/0012; G06Q 40/08; G06T 2207/20081; G06T 2207/30101

(57) ABSTRACT

A method, application program, smart device, and computer system may capture images of a body part of an existing or potential insurance policy holder, determine one or more vital signs of the existing or potential insurance policy holder by image processing optionally assisted by a machine learning model, determine a physiological state for one or more of the vital signs with a computational model generated by another machine learning model, generate an underwriting package containing the physiological state, and send the underwriting package to a central computer for insurance underwriting.

### FIELD OF THE DISCLOSURE

The present disclosure generally relates to the machine-learning based determination of vital signs and a physiological state of a potential or current insurance policy holder for insurance underwriting.

### BACKGROUND

Insurance underwriting primarily relies upon historical data to determine a premium for a policy assigned to a policy holder (e.g., customer of an insurance company). For example, health insurance underwriting systems can use census data and any information collected from an existing or potential policy holder (e.g., gender, age, race) to incorporate into complex formulas for determining the policy premium. The health insurance underwriting systems can also obtain previous health insurance claim information from its databases or from the databases of other health insurance carriers. The historical information is used to calculate medical loss ratio based on the historical information. Life insurance underwriting systems similarly use historical information to determine life insurance premiums. Data that is more recent than historical information, such as blood test results, may be used in life insurance underwriting; however, the blood test results may be several weeks old, or more, by the time the life insurance underwriting is performed.

Health or life insurance premiums are thus determined based upon historical information of an existing or potential policy holder such that the offered premium is effectively associated with a past health status of the existing or potential policy holder. The past health status may be different than the current health status of the existing or potential policy holder, and in some cases, the existing or potential policy holder is a higher risk to the insurance carrier than is reflected in the offered premium.

### SUMMARY

Disclosed is a method including: capturing, by camera of a smart device, a plurality of images of a body part of an existing or potential insurance policy holder; determining, by the smart device, a plurality of hemoglobin concentration (HC) changes based on the plurality of images; determining, by the smart device, a set of bitplanes of the plurality of images that represent the plurality of hemoglobin concentration (HC) changes of the existing or potential insurance policy holder; extracting, by the smart device, a value for a vital sign from the plurality of HC changes; building, by the smart device, a feature set including the plurality of HC changes; performing, by the smart device, a trained machine learning model including a computational model on the feature set to obtain an output data set including a physiological state for the vital sign; generating, by the smart device, an underwriting package including the value for the vital sign and the physiological state for the vital sign; and sending, by the smart device, the underwriting package to a central computer.

Disclosed is a computer system including a smart device, wherein the smart device is configured to: capture, by camera of the smart device, a plurality of images of a body part of an existing or potential insurance policy holder; determine, by an application program running on the smart device, a plurality of hemoglobin concentration (HC) changes based on the plurality of images; determine, by the application program, a set of bitplanes of the plurality of images that represent the plurality of hemoglobin concentration (HC) changes of the existing or potential insurance policy holder; extract, by the application program, a value for a vital sign from the plurality of HC changes; build, by the application program, a feature set including the plurality of HC changes; perform, by the application program, a trained machine learning model including a computational model on the feature set to obtain an output data set including a physiological state for the vital sign; generate, by the application program, an underwriting package including the value for the vital sign and the physiological state for the vital sign; and send, by the application program, the underwriting package to a central computer.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates a schematic diagram of a computer system for machine-learning based determination of vital signs and physiological state of an existing or potential insurance policy holder for insurance underwriting.

FIG. 2A illustrates a flow diagram of a method for machine-learning based determination of one or more vital signs of an existing or potential insurance policy holder for insurance underwriting.

FIG. 2B illustrates a flow diagram of additional steps that can be performed in the method of FIG. 2A.

FIG. 2C illustrates a flow diagram of an additional step that can be performed in the method of FIG. 2A.

FIG. 2D illustrates a flow diagram of an additional step that can be performed in the method of FIG. 2A.

FIG. 2E illustrates a flow diagram of an additional step that can be performed in the method of FIG. 2A.

FIG. 3 illustrates a flow diagram of a method for training a machine learning (ML) model that is used as the computational model in the smart device.

FIG. 4 illustrates a side elevational view of a camera of a smart device capturing a plurality of images of a face of an existing or potential insurance policy holder.

FIG. 5 illustrates a front elevational view of the smart device displaying an exemplary report.

### DETAILED DESCRIPTION

“Application program” or “application” or “app” as used herein refers to instructions stored on and/or running on a computer device of an existing or potential insurance policy holder, which when executed by a processor of the computer device, cause the computer device to perform the function(s) of the application disclosed herein.

“Vital sign” or “vital signs” as used herein can include, but are not limited to, heart rate, respiratory rate, blood pressure, blood oxygen index, temperature, or combinations thereof, of an existing or potential insurance policy holder.

“Physiological state” as used herein refers to a status of a vital sign or combination of vital signs. For example, a physiological state of an existing or potential insurance policy holder's vital sign that is determined by a technique disclosed herein can be normal, elevated, or severe. Additionally or alternatively, the physiological state of the existing or potential insurance policy holder's vital sign that is determined by a technique disclosed herein can be relative to a risk of a medical event, e.g., low risk, normal risk, high risk relative to having a heart attack.

“Existing or potential policy holder,” “existing or potential insurance policy holder,” “potential insurance policy holder,” “potential policy holder,” “existing policy holder,” and “existing insurance policy holder” all refer to a human individual that applying for a new or renewing insurance policy, such as a health insurance policy or life insurance policy for which underwriting is in the process of being performed for purposes of providing an insurance premium to the human individual (e.g., via their computer device that is used to obtain the vital sign(s) and physiological state(s) as disclosed herein.

“Real-time” refers to processing speed of computer processors to perform any of the functions herein and any associated speeds with processing and data transmission between devices and/or computers disclosed herein.

“Near real-time” refers to information delivery which accounts for real-time processing speed of computer processors and data transmission speeds, and delays associated with human use of computer devices disclosed herein. “Near real-time” as used herein also refers to the timing of transmission of the underwriting package relative to performance of an underwriting process in which the underwriting package is used to determine an insurance premium, where the underwriting package is not considered historical information because of the point in time in which the underwriting package is generated relative to the performance of the underwriting process.

Disclosed herein are methods, application program, smart device, and computer system that utilized machine-learning based determination of vital signs and a physiological state of a potential or current insurance policy holder for insurance underwriting (e.g., for health insurance or life insurance). The determination of vital sign(s) and physiological state(s) can be obtained with a smart device and can be provided in near real-time relative to the time at which underwriting is performed. The machine-learning based determinations provide a technical solution to the problem underwriting based on historical information of an existing or potential insurance policy holder that indicates a past health status that may be different than a current health status of the existing or potential insurance policy holder.

The technical solution provided herein captures images of a body part of an existing or potential insurance policy holder, determines one or more vital signs of the existing or potential insurance policy holder by image processing optionally assisted by a machine learning model, determines a physiological state for one or more of the vital signs with a computational model generated by another machine learning model, generates an underwriting package comprising a value for the vital sign and the physiological state for the vital sign, and sends the underwriting package to a central computer (e.g., where the central computer contains, or is in communication with, an underwriting computer).

In aspects, the methods, application program, smart device, and computer system can determine one or more vital signs of an existing or potential insurance policy holder and a physiological state of the existing or potential insurance policy holder. The physiological state can be determined by a smart device running an application program disclosed herein because 1) images of a body part of an existing or potential insurance policy holder can be captured by the camera of the smart device, 2) the images can contain the color signature of hemoglobin concentration (HC), 3) the smart device can be programed to isolate HC changes from the images captured by the camera the smart device, and 4) the HC changes can be correlated to human physiological states. Particularly, a camera of a smart device can capture the re-emission of light from the skin of an existing or potential insurance policy holder's body part using the camera of the smart device. That is, light from a light source can enter the epidermis layer of the skin of the existing or potential insurance policy holder and deflect or reflect from the epidermis and/or one or more layer of skin below the epidermis (e.g., papillary dermis or reticular dermis). The images captured by the camera of the smart device can contain the color signature of hemoglobin concentration in the deflected or reflected light.

Determination of the vital sign(s) and physiological state(s) can also be coordinated by communication of the smart device with a central computer (e.g., where the central computer contains, or is in communication with, an underwriting computer) such that the timing of when the underwriting package disclosed herein is generated and sent to the central computer for underwriting is in near real-time with the underwriting process for determining an insurance premium for the existing or potential insurance policy holder.

The disclosure has the advantage of flexibly being utilized individually to determine a premium for an individual or being utilized by a group of smart devices to determine premiums for group health insurance or group life insurance.

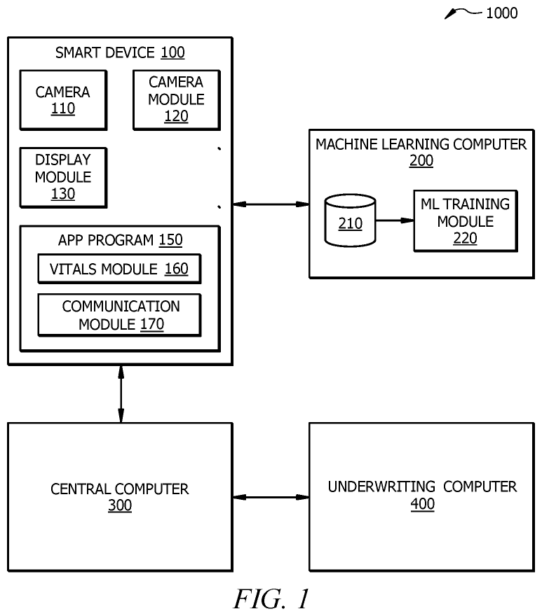

FIG. 1 illustrates a schematic diagram of a computer system 1000 for machine-learning based determination of vital signs and physiological state of an existing or potential insurance policy holder for insurance underwriting. The computer system 1000 can include the smart device 100 (a smart device of an existing or potential insurance policy holder), a machine learning computer 200, a central computer 300, and a underwriting computer 400. While one existing or potential insurance policy holder smart device 100 is illustrated in FIG. 1 as being networked with the machine learning computer 200 and the central computer 300, the disclosure contemplates that a plurality of existing or potential insurance policy holder smart devices can be networked with the machine learning computer 200 and with the central computer 300, where each of the existing or potential insurance policy holder smart devices contains the hardware and software functionality described for smart device 100 herein. Similarly, while underwriting computer 400 is illustrated in FIG. 1 as being networked with the central computer 300, the disclosure contemplates that a plurality of underwriting computers can be networked with the central computer 300, where each of the underwriting computers contains the hardware and software functionality described for underwriting computer 400 herein.

The smart device 100 can be embodied as a smart phone, tablet, laptop, PC, or other computer device. Commercially available smart devices include Apple, Samsung, Google, and Huawei. The smart device 100 can have a camera 110, a camera module 120, a display module 130, and one or more application programs that include the application program 150 of this disclosure. In aspects, the smart device 100 can include chipsets that have a dedicated machine learning interference chip, such as those offered by Samsung, Qualcomm, ARM, Nvidia, or Huawei.

The application program 150 can have a vitals module 160 that is configured to determine one or more vital signs of an existing or potential insurance policy holder and a physiological state of a user of the smart device 100 and a communication module 170 that is configured to package and send the physiological state that is determined by the vitals module 160 to the central computer 300, as described in more detail herein.

The vitals module 160 of the application program 150 of the smart device 100 is configured to receive a first trained computational model from the machine learning computer 200 and to run the first trained computational model in the vitals module 160 to perform functionality described herein. In aspects, the vitals module 160 can periodically receive an updated trained computational model from the machine learning computer 200, replace the first trained computational model with the updated trained computational model, and run the updated trained computational model in the vitals module 160 to perform functionality described herein.

The communication module 170 is configured to package and deliver a message containing vital sign(s) and physiological state associated with an existing policy holder associated with the smart device 100 after the vitals module 160 determines a physiological state. Communications between the vitals module 160 and the communication module 170 are described in more detail herein.

The machine learning computer 200 can include one or more processors, memory, networking cards or interfaces, and other equipment for performing the method and functionality disclosed herein. In embodiments, the machine learning computer 200 can be include multiple computers, located in a brick-and-mortar location, local to the administrator of the machine learning computer 200, in the cloud, or a combination thereof. In FIG. 1, the machine learning computer 200 has a datastore that is configured to store training data. The machine learning computer 200 also has a machine learning (ML) training module 220 that is configured to generate training data sets for training a computational model. The computational model is periodically trained with updated training data sets to generate the updated trained computational model that can be sent by the machine learning computer 200 to the vitals module 160 of the application program 150 running on the smart device 100.

The central computer 300 can include one or more processors, memory, networking cards or interfaces, and other equipment for performing the method and functionality disclosed herein. The central computer 300 is configured to administer real-time delivery of vitals and physiological state messages from the smart device 100 to the underwriting computer 400 of a health insurance or life insurance carrier, and can utilize real-time gateway routing by which the central computer 300 can match the smart device 100 with the underwriting computer 400, for a real-time delivery of message from the smart device 100 to the underwriting computer 400. In aspects, the underwriting computer 400 and the central computer 300 are the same computer.

In embodiments, the central computer 300 can include multiple computers, located in a brick-and-mortar location, local to the administrator of the central computer 300, in the cloud, or a combination thereof. In embodiments, the central computer 300 can include a distributed computer architecture, such that hardware is geographically distributed, with the hardware that is geographically closest to the smart device 100 communicating with the smart device 100. In some aspects, the central computer 300 can include computers embodied as servers that are scalable in the cloud, such as those available from Amazon Web Services.

The underwriting computer 400 can include multiple computers, located in a brick-and-mortar location, local to the administrator of the central computer 300, in the cloud, or a combination thereof. In embodiments, the central computer 300 can include a distributed computer architecture, such that hardware is geographically distributed, with the hardware that is geographically closest to the smart device 100 communicating with the smart device 100. In some aspects, the central computer 300 can include computers embodied as servers that are scalable in the cloud, such as those available from Amazon Web Services.

The smart device 100 is networked with the machine learning computer 200 and with the central computer 300.

The smart device 100 and the machine learning computer 200 can be networked via any wired internet connection, wireless internet connection, local area network (LAN), wired intranet connection, wireless intranet connection, or combinations thereof. The networks used for communication between the smart device 100 and the machine learning computer 200 can include a Global System for Mobile Communications (GSM), Code-division multiple access (CDMA), General Packet Radio Service (GPRS), Evolution-Data Optimized (EV-DO), Enhanced Data Rates for GSM Evolution (EDGE), Universal Mobile Telecommunications System (UMTS), etc.

The smart device 100 and the central computer 300 can be networked via any wired internet connection, wireless internet connection, local area network (LAN), wired intranet connection, wireless intranet connection, or combinations thereof. The networks used for communication between the smart device 100 and the central computer 300 can include a Global System for Mobile Communications (GSM), Code-division multiple access (CDMA), General Packet Radio Service (GPRS), Evolution-Data Optimized (EV-DO), Enhanced Data Rates for GSM Evolution (EDGE), Universal Mobile Telecommunications System (UMTS), etc.

In aspects where the underwriting computer 400 and central computer 300 are separate computers, the underwriting computer 400 is networked with the central computer 300. The underwriting computer 400 and the central computer 300 can be networked via any wired internet connection, wireless internet connection, local area network (LAN), wired intranet connection, wireless intranet connection, or combinations thereof. The networks used for communication between the underwriting computer 400 and the central computer 300 can include a Global System for Mobile Communications (GSM), Code-division multiple access (CDMA), General Packet Radio Service (GPRS), Evolution-Data Optimized (EV-DO), Enhanced Data Rates for GSM Evolution (EDGE), Universal Mobile Telecommunications System (UMTS), etc.

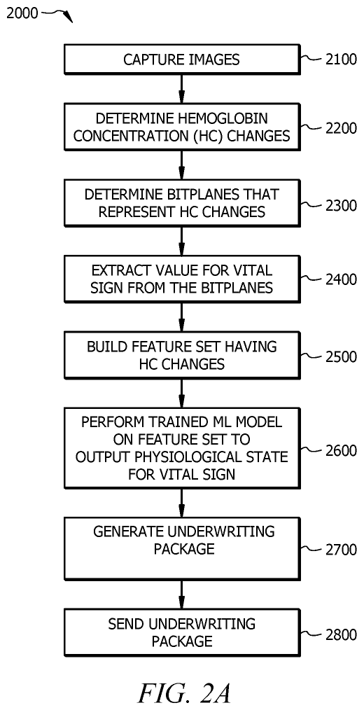

FIG. 2A illustrates a method 2000 for determining one or more vital signs and one or more physiological states associated with the one or more vital signs. The method 2000 is described with reference to components of the computer system 1000 in FIG. 1. The steps of the method 2000 are generally performed by the smart device 100.

In step 2100, the method 2000 includes capturing, by the camera 110 of the smart device 100, a plurality of images of a body part of an existing or potential insurance policy holder. The camera module 120 of the smart device 100 can control the camera 110 to capture the plurality of images. The user of the smart device 100 (e.g., the existing or potential insurance policy holder) can initiate image capture by instructing the application program 150 to engage with the camera module 120 for image capture (e.g., via a virtual button displayed on the screen of the smart device 100 by the application program 150). The camera module 120 can be configured to cause the camera 110 to capture images at 1, 2, 3, 4, 5, 6, 7, 8, 9, 10, 20, 30, 40, or 50 frames per second, for example. The camera module 120 can be configured to cause the camera 110 to capture images for a period of time, e.g., 5, 10, 15, 20, 25, or 30 seconds; such that changes in hemoglobin concentrations can be determined from the images. The camera module 120 can be configured to construct a file containing a plurality of photo images (e.g., JPEG, PNG formats) or a video file (e.g., MP4, etc.) and send the file to the application program 150. The application program 150 can receive the file from the camera module 120 of the smart device 100.

In step 2200, the method 2000 includes determining, by the smart device 100, a plurality of hemoglobin concentration (HC) changes based on the plurality of images. The images captured by the camera of the smart device can contain the color signature of hemoglobin concentration in the deflected or reflected light. The plurality of HC changes can be determined using the color signatures of the HCs in the images.

In step 2300, the method 2000 includes determining, by the smart device 100, a set of bitplanes of the plurality of images that represent the plurality of hemoglobin concentration (HC) changes of the existing or potential insurance policy holder. In aspects, the set of bitplanes has a high signal to noise ratio (SNR). In aspects, a set of bitplanes having a high SNR is a set of bitplanes that optimizes or maximizes signal differentiation between different physiological states under the epidermis of the body part of the existing or potential insurance policy holder. In aspects, the vitals module 160 can include a machine learning model to determine the set of bitplanes having a red-green-blue (RGB) pixel bit-combination that maximizes the SNR. An example of a suitable machine learning model can be a K-means clustering model or a Long Short Term Memory (LSTM) neural network model that can obtain an accuracy of signal differentiation and that can determine which bitplane(s) have the highest SNR. The vitals module 160 can be configured to feed the output results of the machine learning model back as input into the machine learning model until two successive machine learning output results have values that are within a tolerance, such as +/−5, 4, 3, 2, or 1%, of one another. In aspects, ML model can be performed on only a portion of the total amount of data (e.g., 70%, 80%, 90% of the bitplanes data), and the vitals module 160 can use the remaining bitplanes data to validate the output of the ML model. In additional aspects, the ML model in step 2300 can be a trained ML model that is trained (e.g., by the machine learning computer 200 or by the application program 150) using a training set of images comprising the plurality of images from a training set of existing or potential insurance policy holders, EKG data from the training set of existing or potential insurance policy holders, pneumatic respiration data from the training set of existing or potential insurance policy holders, blood pressure data from the training set of existing or potential insurance policy holders, laser Doppler data from the training set of existing or potential insurance policy holders, oximeter data from the training set of existing or potential insurance policy holders, or combinations thereof.

In step 2400, the method 2000 includes extracting, by the smart device 100, a value for a vital sign from the bitplanes. An empirically-based HC isolation procedure can be performed on the HC changes, and the set of bitplanes that provides the highest SNR for a vital sign can be determined from the HC changes. The vital sign values can be extracted from the bitplanes. For example, the vital signs of heart rate, respiratory rate, blood pressure, and blood oxygenation index can be extracted by analyzing bitplanes of the plurality of images to determine and isolate a set of the bitplanes that most accurately correlate with EKG, pneumatic respiration, blood pressure, and the blood oxygenation machine data. The extracted vital sign value(s) can be displayed on the smart device 100 (e.g., via the report).

In step 2500, the method 2000 includes building, by the smart device 100, a feature set comprising the plurality of HC changes. In aspects, the feature set can also include stress level ratio(s) for value(s) of the vital sign. For example, one or more digital signal transformations (e.g. Fourier transformations) can be performed on the value of the vital and to obtain a stress level index. By comparing the stress level index against a normative stress index distribution profile that is included with the application program 150, a comparative stress ratio can be determined for the existing or potential insurance policy holder.

In step 2600, the method 2000 includes performing, by the smart device 100, a trained machine learning (ML) model on the feature set to obtain an output data set comprising a physiological state for the vital sign. In aspects, the trained ML model performed in step 2600 of the method 2000 is not the same model that may optionally be utilized in step 2300 of the method 2000. In aspects, the trained ML model can classify the HC changes as corresponding to a physiological state of the vital sign (or a combination of vital signs) of the existing or potential insurance policy holder.

In aspects of this disclosure, the trained ML model that is run on the application program 150 of the smart device 100 is received from the machine learning computer 200. As such, the trained ML model is a computational model that processes a feature set to obtain an output data set. The trained ML model running on the smart device 100 is not continuously updated by the smart device 100. Instead, in these aspects, the machine learning computer 200 continuously or periodically trains the computational model to produce an updated trained ML model (e.g., an updated computational model), and the application program 150 is configured to receive the updated trained ML model from the machine learning computer 200. The updated trained ML model is a later version of the earlier version of the computational model, that can be performed on another feature set to obtain another output data set. The machine learning computer 200 can send or propagate an updated trained ML model to the application program 150 of the smart device 100 periodically, such as daily, weekly, monthly, quarterly, semi-annually, or annually.

In alternative aspects of this disclosure, the smart device 100 can be equipment with chipsets configured for machine learning interference processing on the smart device 100 itself, e.g., an Ethnos model of chipsets commercially available from ARM. In such aspects, the vitals module 160 can use output data sets of the trained ML model to continuously or periodically train the trained ML model running on the vitals module 160 in order to update the trained ML model.

In step 2700, the method 2000 includes generating, by the smart device 100, an underwriting package comprising the vital sign value and physiological state associated with the vital sign value. In aspects, a physiological state for each vital sign can be determined, and as such, a plurality of physiological states are determined where a first physiological state corresponds to a first vital sign, a second physiological state corresponds to a second vital sign, and so on. In aspects, a comprehensive physiological state can correspond to a combination of vital signs.

In step 2800, the method 2000 includes sending, by the communication module 170 running on the smart device 100, the underwriting package to the central computer 300, based completion of the generating step 2700.

The communication module 170 can be part of the application program 150. Thus, installation of the application program 150 can install the communication module 170 on the smart device 100.

The central computer 300 can determine the proper underwriting computer 400 of a proper insurance carrier. In some aspects, the central computer 300 can include a mapping file that maps the IP address of the smart device 100 with the underwriting computer 400. The communication module 170 can send the underwriting package to the central computer 300, and the central computer 300 can analyze the underwriting package and the IP address of the smart device 100 to determine the proper underwriting computer 400 to send the underwriting package. In other aspects, the vitals module 160 can be configured to receive input data from the existing or potential insurance policy holder via an insurance provider input screen that can be displayed by display module 130 on the smart device 100. The vitals module 160 can store the input data for retrieval by the communication module 170. The communication module 170 can be configured to retrieve the input data from the input file for inclusion in the underwriting package. The communication module 170 can then send the underwriting package to the central computer 300 for underwriting by the central computer 300 (in aspects where the underwriting computer 400 is part of the central computer 300) or for the central computer 300 to forward to the underwriting computer 400 (e.g., using the mapping file to determine the underwriting computer 400 is the proper underwriting computer from a plurality of underwriting computers).

In aspects, the vitals module 160 can activate the communication module 170 automatically without the existing or potential insurance policy holder input between steps 2700 and 2800 of the method. Alternatively, the vitals module 160 can prompt, via a screen of the smart device 100, the existing or potential insurance policy holder for input (e.g., a virtual button) which is received prior to activating the communication module 170.

FIGS. 2B, 2C, and 2D illustrate additional steps that optionally can be performed in the method 2000, in any combination of the steps.

FIG. 2B illustrates a flow diagram of additional steps 2010 and 2020 that can be performed in the method 2000. Steps 2010 and 2020 establish communication between the central computer 300 with the application program 150 running on the smart device 100 so that delivery of the underwriting package after performance of the method 2000 in FIG. 2A is in near real-time relative to the underwriting process for determining the insurance premium to be offered to the existing or potential insurance policy holder. In aspects, a time period between when the notification message is sent and the underwriting package is sent is near real-time.

In step 2010, the method 2000 can include, prior to capturing, sending, by the smart device 100, a notification message to the central computer 300. The notification message can contain data information that the application program 150 is running on the smart device 100 (indicating that the existing or potential insurance policy holder is engaged with the smart device 100). The notification message can be sent by the application program 150 running on the smart device 100 in response to an interaction of the existing or potential insurance policy holder, such as opening the application program 150 and then selecting a virtual button to initiate a scan for purposes of insurance underwriting as described herein.

In step 2020, the method 2000 can include prior to capturing and after sending the notification message, receiving, by the smart device 100 from the central computer 300, a request to scan the body part of the existing or potential insurance policy holder. In aspects, the central computer 300 sends the request to the smart device 100 in response to receiving the notification message from the smart device 100. Receiving the request to scan can cause the smart device 100 to engage the display module 130 to display a prompt on a display of the smart device 100, where the prompt (e.g., virtual button, pop up window) can be selected by the existing or potential insurance policy holder in order to initiate a scan (e.g., initiate capture of images as described herein).

FIG. 2C illustrates a flow diagram of an additional step 2650 that can be performed in the method 2000.

In step 2650, the method 2000 can include determining, by the smart device 100, a classification for the physiological state for the vital sign, wherein the underwriting package includes the classification. In aspects, the classification can be normal, elevated, or severe. To determine the classification, the application program 150 (e.g., via the vitals module 160) can include a mapping file for the classification of the physiological state based on the value for the vital sign, or based on values for two or more vital signs. The value(s) for the vital sign(s) can be mapped to a classification for the physiological state by the application program 150, and the vitals module 160 can be configured include the classification as part of the underwriting package.

FIG. 2D illustrates a flow diagram of an additional step 2900 that can be performed in the method 2000. In aspects, step 2900 can be performed after performance of step 2800.

In step 2900, the method 2000 can include receiving, by the smart device 100 from the central computer 300, an insurance policy premium that was determined based at least in part on the underwriting package. The central computer 300, underwriting computer 400, or both can determine the insurance policy premium according to any technique for health insurance or life insurance underwriting known in the art with the aid of this disclosure. Generally information is collected by an insurance provider that can be associated with (e.g., mapped to, based on a common characteristic with generic information such as age, race, weight, geographic location) or directly applicable to (e.g., actual health insurance claims, health records) the existing or potential insurance policy holder. The historical information can be analyzed against metrics to determine a risk factor associated with the existing or potential insurance policy holder. The risk factor is the used to calculate a premium that can be offered to the existing or potential insurance policy holder. The method and system described herein additionally or alternatively utilize the underwriting package generated by the smart device 100 after the machine-learning based determination of vital signs and physiological state.

FIG. 2E illustrates a flow diagram of an additional step 2030 that can be performed in the method 2000 of FIG. 2A.

In step 2030, the method 2000 can include capturing, by the smart device 100, a photo ID of the existing or potential insurance policy holder. This step 2030 can be performed before or after step 2100 of method 2000 in FIG. 2A. For example, the vitals module 160 of the application program 150 can engage the display module 130 to display a message on the display of the smart device 100 to take a photo of the existing or potential insurance policy holder's photo ID. After selection of a virtual button associated with the message on the display, the application program 150 can engage the camera module 120 to have camera 110 take a digital image of the photo ID (the existing or potential insurance policy holder has to hold the photo ID in front of the camera 110 of the smart device 100).

In aspects, the application program 150 (e.g., via the vitals module 160 or the communication module 170) can include an image file comprising the photo ID as part of the underwriting package that is sent to central computer 300. In additional aspects where the captured images in step 2100 are of the face of the existing or potential insurance policy holder, the application program 150 can be configured to extract an image file comprising the face from the images captured in step 2100, and include the extracted image comprising the face in the underwriting package in combination with the image file comprising the photo ID. The extracted image and image file can be compared by the central computer 300, underwriting computer 400, or both, for validation that the existing or potential insurance policy holder that was scanned to capture images in step 2100 is the same existing or potential insurance policy holder that is applying for insurance underwriting. For example, the central computer 300, underwriting computer 400, or both can utilize image comparison technology such as image-based facial recognition technology known in the art with the aid of this disclosure.

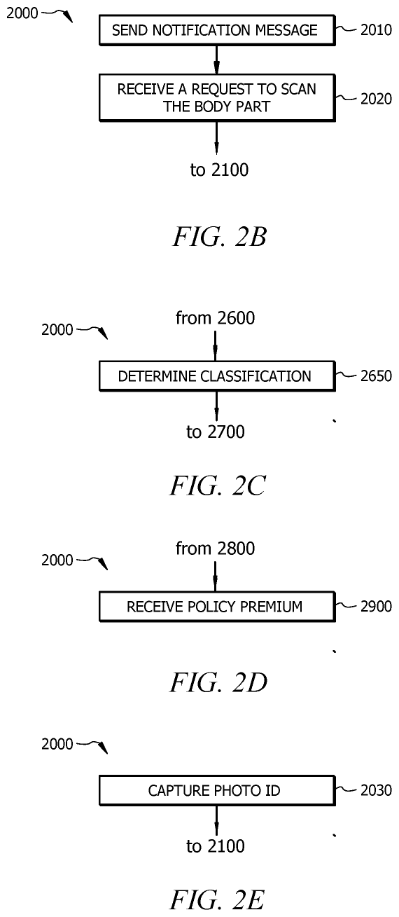

FIG. 3 illustrates a flow diagram of a method 3000 for training a machine learning (ML) model that is used as the computational model in the vitals module 160 of the application program 150 running on the smart device 100. The method 3000 is described with reference to the components of the computer system 1000, and particularly with reference to the method 3000 being performed by the ML training module 220 of the machine learning computer 200. Alternative aspects contemplate that the method 3000 can be performed by the vitals module 160 or other module on the application program 150 running on the smart device 100, for example, in aspects where the smart device 100 has a dedicated machine learning interference chipset and memory storage capacity for training data sets.

In step 3100, the method 3000 includes receiving data, by the machine learning computer 200. In aspects, the data can be received from one or more smart devices (e.g., including smart device 100). The data received from any smart device can include any of the data received and generated by the application program 150 and similar application programs on other smart devices. For example, the data received by the machine learning computer 200 can include a file containing a plurality of images from a single scan run on the application program 150 of the smart device 100, several files each containing a plurality of images from several scans run on the application program 150 of the smart device 100, values of HC changes, determined bitplanes for a plurality of images, output results from the machine learning model that is run on the vitals module 160, one or more files containing images, HC changes, bitplanes, output results, or combinations thereof from any number of smart devices that similarly have the application program 150 running thereon.

In additional aspects of step 3100, the data can additionally be received from other data sources. For example, the machine learning computer 200 can receive and store training data from any source. The training data can include images (e.g., files of a sequence of still images or files of video images) of training existing or potential insurance policy holders that were exposed to stimuli known to elicit specific physiological states (e.g., the International Affective Picture System). Responses may be grouped in a manner that can be reported and communicated as a physiological state of one or a combination of vital signs (e.g., normal, elevated, and severe; or low stress, moderate stress, and high stress; or low pain, moderate pain, and high pain). In aspects, the training data set containing data from existing or potential insurance policy holders having groups of different skin types. The training data can include images (e.g., files of a sequence of still images or files of video images) of training existing or potential insurance policy holders that were exposed to stimuli known to elicit specific physiological states (e.g., stimuli from the International Affective Picture System, and/or non-visual stimuli, such as auditory stimuli, taste stimuli, smell stimuli, touch stimuli, or combinations thereof). The training data can additionally include EKG data, pneumatic respiratory data, blood pressure data, and laser Doppler data, and blood oxygenation data of the training existing or potential insurance policy holders.

The data received by the machine learning computer 200 can be used to build a training data set that is used to build a training feature set for the second machine learning (ML) model in the ML training module 220. In aspects, the training data set contains all data stored at a point in time in the datastore 210 by the machine learning computer 200; alternatively, the training data set contains only all the images stored in the datastore 210. Any data received by the machine learning computer 200 can be stored by the machine learning computer 200 in datastore 210, for access or retrieval when the machine learning computer 200 builds the training data set.

In step 3200, the method 3000 includes determining, by the ML training module 220 of the machine learning computer 200, a plurality of hemoglobin concentration (HC) changes based the images contained in the training data set.

In step 3300, the method 3000 includes determining, by the ML training module 220 of the machine learning computer 200, a set of bitplanes of the images in the training data set that represent the plurality of hemoglobin concentration (HC) changes in the images of the training data set. In aspects, the set of bitplanes has a high signal to noise ratio (SNR). In aspects, a set of bitplanes having a high SNR is a set of bitplanes that optimizes or maximizes signal differentiation between different physiological states under the epidermis of the body part(s) that is/are in the images. In aspects, the ML training module 220 can include a first machine learning (ML) model to determine the set of bitplanes having a red-green-blue (RGB) pixel bit-combination that maximizes the SNR. An example of a suitable first ML model that determines bitplanes can be a K-means clustering model or a Long Short Term Memory (LSTM) neural network model that can obtain an accuracy of signal differentiation and that can determine which bitplane(s) have the highest SNR. The ML training module 220 can be configured to feed the output results of the first ML model back as input into the first ML model until two successive machine learning output results have values that are within a tolerance, such as +/−5, 4, 3, 2, or 1%, of one another.

In aspects, the first ML model in the ML training module 220 can be the same ML model that is used in the vitals module 160. However, the first ML model in the ML training module 220 determines bitplanes for HC changes based on images from the training data set (images from many existing or potential insurance policy holders, training existing or potential insurance policy holders, etc.), while the ML model on the vitals module 160 determines bitplanes for the HC changes from the plurality of images captured by the smart device 100 for the specific existing or potential insurance policy holder. Using the same ML model in the ML training module 220 and in the vitals module 160 provides a first layer of data alignment so that the computational model that is trained in the ML training module 220 and sent to the vitals module 160 provides more accurate results for the specific existing or potential insurance policy holder using the smart device 100.

In step 3400, the method 3000 includes extracting spatial-temporal features from the set of bitplanes that are determined in step 3300, to create a training feature set for the second machine learning (ML) model that is trained om step 3500 to generate the computational model for use in the method 2000. In aspects, a training feature set can be created for each physiological state and a computational model can be generated for each physiological state.

In step 3500, the method 3000 includes performing the second machine learning (ML) model on the training feature set(s) created in step 3400 to generate the computational model that determines a physiological state for an input data set comprising bitplanes described herein. The output of the second ML model is the physiological state for the training feature set. In aspects, the second ML model can be a Long Short Term Memory (LSTM) neural network model or a support vector network model (e.g., utilizing nonlinear classification). In aspects, the second ML model can be performed on only a portion of the total amount of data (e.g., 70%, 80%, 90% of the training feature set), and the ML training module 220 can use the remaining data in the training feature set to validate the output of the second ML model.

In aspects, step 3500 is a training step for the second ML model, and the ML training module 220 can be configured to feed the output results of the second ML model back as input into the second ML model until two successive machine learning output results have values that are within a tolerance, such as +/−5, 4, 3, 2, or 1%, of one another.

After step 3500 is performed (with or with feedback), the second ML model can be used as the computational model that is sent to smart devices (e.g., smart device 100) as an updated version of the model used in the vitals module 160.

It should be noted that the computational model generated in method 3000 provides output for a physiological state of the training feature set that was input to the second ML model. The computational model will not output a physiological state for which it was not trained.

In aspects of the disclosure where the method 3000 is performed by the machine learning computer 200, the machine learning computer 200 can be configured to send or propagate the computational model (also referred to as the second ML model, the updated second ML model, or the updated computational model if method 3000 has already been performed to generate a previous version of the computational model) to the smart device 100 and any other smart device running the application program 150.

In aspects of the disclosure where the method 3000 is performed by the smart device 100, the vitals module 160 of the application program 150 of the smart device 100 can be configured to replace the existing computational model with the updated computational model and run the updated computational model.

### Regions of Interest

In aspects of both methods 2000 and 3000, the data can be divided into regions of interest (ROIs) for a body part (e.g., nose, cheek, forehead for a face of an existing or potential insurance policy holder and the training existing or potential insurance policy holders). For different ROIs, method 3000 can be repeated to generate a computational model to determine the physiological state in each ROI. That is, the method 3000 can be performed for every ROI to generate a computational model for each ROI. It is thus contemplated that multiple computational models (e.g., each corresponding to a particular ROI of a body part) can be generated and sent to the application program 150 on the smart device 100. Subsequently, the method 2000 can be performed for each ROI to determine the physiological state in each ROI. It is believed that dividing data into ROIs can increase SNR. The physiological state for each ROI can then be compared or averaged to determine an overall physiological state.

### Long Short Term (LSTM) Neural Network Model

For embodiments that utilize a LSTM neural network model, the LSTM neural network model can comprise at least three layers. The first layer is an input layer, which accepts the input data. The second layer is at least one hidden layer, where each hidden layer comprises memory cells. The final layer is an output layer that can generate the output data value based on the hidden layer(s) using a regression technique, such as logistic regression.

Each memory cell in the second layer can include an input gate, a neuron with a self-recurrent connection (a connection to itself), a forget gate, and an output gate. The self-recurrent connection can have a weight (e.g., a weight value of 1.0) so that the state of a memory cell can remain constant from one time step to another. The input gate can permit or prevent an incoming signal to alter the state of the memory cell, the output gate can permit or prevent the state of the memory cell to have an effect on other memory cells, and the forget gate can modulate the self-recurrent connection so that the memory cell remembers or forgets a previous state.

The following equations describe how a layer of memory cells is updated at every time step t, using blood flow as example. In these equations: \vec{(x)ₜ}=[x₁ₜ,x₂ₜ, . . . xₙₜ] is an input array to the memory cell layer at time t; Wᵢ, W_{f}, W_{c}, Wₒ, Uᵢ, U_{f}, U_{c}, Uₒ and Vₒ are weight matrices; and bᵢ, b_{f}, b_{c} and bₒ are bias vectors. First, compute the values for iₜ (the input gate) and \tilde{C}ₜ (the candidate value for the states of the memory cells at time t): iₜ=σ(Wᵢxᵢ+Uᵢhₜ−1+bᵢ); and \tilde{C}ₜ(W_{c}xₜ+U_{c}hₜ₋₁+b_{c}). Second, compute the value for fₜ (the activation of the forget gates at time t): fₜ=σ(W_{f}xₜ+U_{f}hₜ₋₁+b_{f}). Third, compute Ct (the memory cells' new state at time t): Cₜ=iₜ*\tilde{C}ₜ+fₜ*Cₜ₋₁. Fourth, compute the value of the output gates and the outputs of the output gates: o_{f}=σ(Wₒxₜ+Uₒhₜ₋₁VₒCₜ+bₒ); and hₜ=oₜ*tan h(Cₜ). Based on the model of memory cells, for the blood flow distribution at each time step, we can calculate the output from memory cells. From an input sequence (e.g., x₀, x₁, x₂, . . . ), the memory cells in the hidden layer(s) will produce a representation sequence (e.g., h₀, h₁, h₂ . . . ).

In aspects, the representation sequence can be classified into different conditions. The output layer can generate a probability of each condition based on the representation sequence from the LSTM hidden layer(s). The vector of the probabilities at time step t can be calculated according to the following equation: pₜ=softmax (Wₒᵤₜₚᵤₜhₜ+bₒᵤₜₚᵤₜ), where Wₒᵤₜₚᵤₜ is the weight matrix from the hidden layer to the output layer, and bₒᵤₜₚᵤₜ is the bias vector of the output layer. The condition with the maximum accumulated probability is the predicted condition of a sequence.

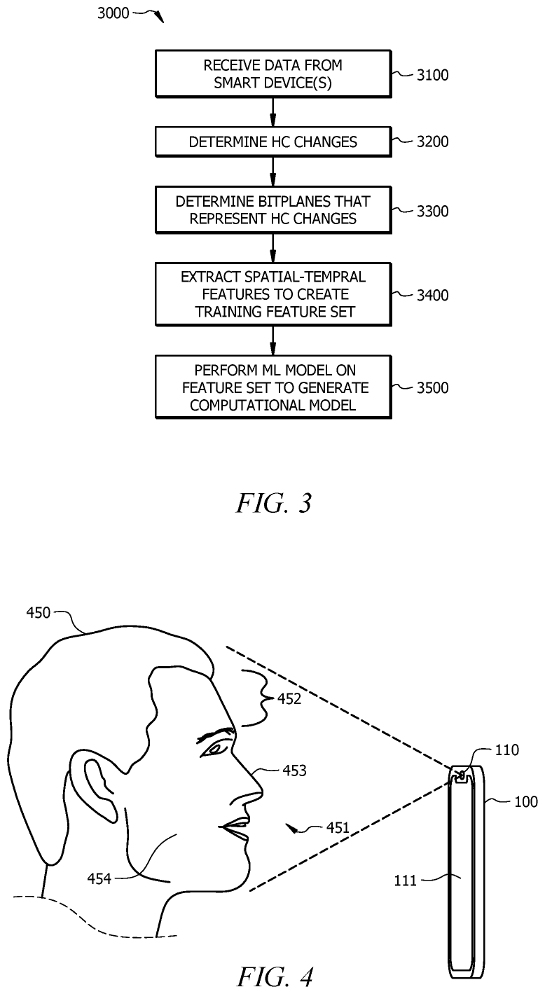

FIG. 4 illustrates a side elevational view of a camera 110 of a smart device 100 capturing a plurality of images of a face 451 of existing or potential insurance policy holder 450. The regions of interest, e.g., the forehead 452, the nose 453, and the cheek 454 can be seen within the view of the camera 110 of the smart device 100. The smart device 100 is configured to perform the method 2000 of FIG. 2A to display a report of vital sign values and physiological state(s) associated with the vital sign values on the screen 111 of the smart device 100.

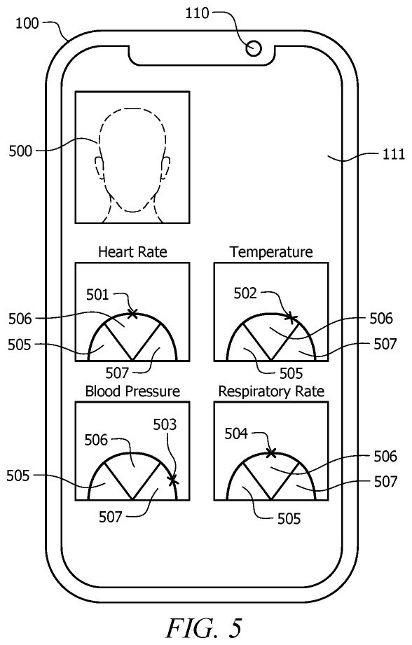

FIG. 5 illustrates a front elevational view of the smart device 100 displaying an exemplary report that can be displayed on the smart device 100 (e.g., after the underwriting package is sent to the central computer 300). The vitals module 160 can cause the display module 130 of the smart device 100 to display the report on the screen 111 of the smart device 100. The report can include a photo 500 of the existing or potential insurance policy holder. The vital signs illustrated in FIG. 5 are heart rate, temperature, blood pressure, and respiration rate. The vital sign values 501, 502, 503, and 504 correspond to the vital signs of heart rate, temperature, blood pressure, and respiration rate, respectively. The physiological states in FIG. 5 are normal state 505, elevated state 506, and severe state 507. Each vital sign value 501, 502, 503, and 504 is displayed relative to the physiological states of normal state 505, elevated state 506, and severe state 507. That is vital sign value 501 for heart rate is in the elevated state 506. The vital sign value 502 for temperature is in the elevated state 506, close to the border between the elevated state 506 and the severe state 507. The vital sign value 503 for blood pressure is in the severe state 507. The vital sign value 504 for respiratory rate is in the elevated state 506.

In aspects, all of the vital signs and physiological states displayed in FIG. 5 are part of the underwriting package that is sent to the central computer 300.

While the vital sign values 501, 502, 503, and 504 are illustrated as “X”s relative to a pie-type chart of physiological states, it is contemplated that the vital sign values 501, 502, 503, and 504 can be illustrated in other manners, such as in bar graph format with a color of the bar indicating the physiological state (e.g., green is normal physiological state for the vital sign value, yellow is elevated physiological state for the vital sign value, and red is severe physiological state for the vital sign value).

### ADDITIONAL DISCLOSURE

Accordingly, the scope of protection is not limited by the description set out above but is only limited by the claims which follow, that scope including all equivalents of the subject matter of the claims. Each and every claim is incorporated into the specification as part of the disclosure. Thus, the claims are a further description and are an addition to the detailed description. The disclosures of all patents, patent applications, and publications cited herein are hereby incorporated by reference.

Clause 1. A method comprising: capturing, by camera of a smart device, a plurality of images of a body part of an existing or potential insurance policy holder; determining, by the smart device, a plurality of hemoglobin concentration (HC) changes based on the plurality of images; determining, by the smart device, a set of bitplanes of the plurality of images that represent the plurality of hemoglobin concentration (HC) changes of the existing or potential insurance policy holder; extracting, by the smart device, a value for a vital sign from the plurality of HC changes; building, by the smart device, a feature set comprising the plurality of HC changes; performing, by the smart device, a trained machine learning model comprising a computational model on the feature set to obtain an output data set comprising a physiological state for the vital sign; generating, by the smart device, an underwriting package comprising the value for the vital sign and the physiological state for the vital sign; and sending, by the smart device, the underwriting package to a central computer.

Clause 2. The method of clause 1, further comprising: receiving, by the smart device from the central computer, an insurance policy premium that was determined based at least in part on the underwriting package.

Clause 3. The method of clause 2, further comprising: prior to capturing, sending, by the smart device, a notification message to the central computer; and prior to capturing and after sending the notification message, receiving, by the smart device from the central computer, a request to scan the body part of the existing or potential insurance policy holder.

Clause 4. The method of clause 1, 2, or 3, performed in near real-time.

Clause 5. The method of any one of clauses 1 to 4, further comprising: determining, by the smart device, a classification for the physiological state for the vital sign, wherein the underwriting package includes the classification.

Clause 6. The method of clause 5, wherein the classification is normal, elevated, or severe.

Clause 7. The method of any one of clauses 1 to 6, further comprising: receiving, by the smart device from a machine learning computer, the trained machine learning model.

Clause 8. The method of any one of clauses 1 to 7, wherein the trained machine learning model is a K-means clustering model or a neural network model.

Clause 9. The method of any one of clauses 1 to 8, further comprising: receiving, by a machine learning computer from the smart device, the plurality of images; determining, by a ML training module of the machine learning computer, a second plurality of hemoglobin concentration (HC) changes based on the plurality of images; determining, by the ML training module of the machine learning computer, a second set of bitplanes of the plurality of images that represent the second plurality of hemoglobin concentration (HC) changes; extracting, by the ML training module of the machine learning computer, spatial-temporal features from the second set of bitplanes; creating, by the ML training module of the machine learning computer, a training feature set; and performing, by the ML training module of the machine learning computer, a second machine learning model on the training feature set to generate the computational model.

Clause 10. The method of clause 9, wherein an output of the second machine learning model is the physiological state.

Clause 11. A computer system comprising a smart device, wherein the smart device is configured to: capture, by camera of the smart device, a plurality of images of a body part of an existing or potential insurance policy holder; determine, by an application program running on the smart device, a plurality of hemoglobin concentration (HC) changes based on the plurality of images; determine, by the application program, a set of bitplanes of the plurality of images that represent the plurality of hemoglobin concentration (HC) changes of the existing or potential insurance policy holder; extract, by the application program, a value for a vital sign from the plurality of HC changes; build, by the application program, a feature set comprising the plurality of HC changes; perform, by the application program, a trained machine learning model comprising a computational model on the feature set to obtain an output data set comprising a physiological state for the vital sign; generate, by the application program, an underwriting package comprising the value for the vital sign and the physiological state for the vital sign; and send, by the application program, the underwriting package to a central computer.

Clause 12. The computer system of clause 11, wherein the application program of the smart device is further configured to: receive, from the central computer, an insurance policy premium that was determined based at least in part on the underwriting package.

Clause 13. The computer system of clause 11 or 12, wherein the application program of the smart device is further configured to: prior to capturing, send a notification message to the central computer; and prior to capturing and after sending the notification message, receive from the central computer, a request to scan the body part of the existing or potential insurance policy holder.

Clause 14. The computer system of clause 11, 12, or 13, wherein a time period between when the notification message is sent and the underwriting package is sent is near real-time.

Clause 15. The computer system of any one of clauses 11 to 14, wherein the application program of the smart device is further configured to: determine a classification for the physiological state for the vital sign, wherein the underwriting package includes the classification.

Clause 16. The computer system of clause 15, wherein the classification is normal, elevated, or severe.

Clause 17. The computer system of any one of clauses 11 to 16, wherein the application program of the smart device is further configured to: receive, from a machine learning computer, the trained machine learning model.

Clause 18. The computer system of any one of clauses 11 to 17, wherein the trained machine learning model is a K-means clustering model or a neural network model.

Clause 19. The computer system of any one of clauses 11 to 18, further comprising a machine learning computer, wherein the machine learning computer is configured to: receive, from the smart device, the plurality of images; determine, by a ML training module of the machine learning computer, a second plurality of hemoglobin concentration (HC) changes based on the plurality of images; determine, by the ML training module of the machine learning computer, a second set of bitplanes of the plurality of images that represent the second plurality of hemoglobin concentration (HC) changes; extract, by the ML training module of the machine learning computer, spatial-temporal features from the second set of bitplanes; create, by the ML training module of the machine learning computer, a training feature set based on the spatial-temporal features; and perform, by the ML training module of the machine learning computer, a second machine learning model on the training feature set to generate the computational model.

Clause 20. The computer system of clause 19, wherein an output of the second machine learning model is the physiological state.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method comprising:
capturing, by camera of a smart device, a plurality of images of a body part of an existing or potential insurance policy holder;
determining, by the smart device, a plurality of hemoglobin concentration (HC) changes based on the plurality of images;
determining, by the smart device, a set of bitplanes of the plurality of images that represent the plurality of hemoglobin concentration (HC) changes of the existing or potential insurance policy holder;
extracting, by the smart device, a value for a vital sign from the plurality of HC changes;
building, by the smart device, a feature set comprising the plurality of HC changes;
performing, by the smart device, a trained machine learning model comprising a computational model on the feature set to obtain an output data set comprising a physiological state for the vital sign;
generating, by the smart device, an underwriting package comprising the value for the vital sign and the physiological state for the vital sign; and
sending, by the smart device, the underwriting package to a central computer.

2. The method of claim 1, further comprising:
receiving, by the smart device from the central computer, an insurance policy premium that was determined based at least in part on the underwriting package.

3. The method of claim 2, further comprising:
prior to capturing, sending, by the smart device, a notification message to the central computer; and
prior to capturing and after sending the notification message, receiving, by the smart device from the central computer, a request to scan the body part of the existing or potential insurance policy holder.

4. The method of claim 3, performed in near real-time.

5. The method of claim 1, further comprising:
determining, by the smart device, a classification for the physiological state for the vital sign, wherein the underwriting package includes the classification.

6. The method of claim 5, wherein the classification is normal, elevated, or severe.

7. The method of claim 1, further comprising:
receiving, by the smart device from a machine learning computer, the trained machine learning model.

8. The method of claim 1, wherein the trained machine learning model is a K-means clustering model or a neural network model.

9. The method of claim 1, further comprising:
receiving, by a machine learning computer from the smart device, the plurality of images;
determining, by a ML training module of the machine learning computer, a second plurality of hemoglobin concentration (HC) changes based on the plurality of images;
determining, by the ML training module of the machine learning computer, a second set of bitplanes of the plurality of images that represent the second plurality of hemoglobin concentration (HC) changes;
extracting, by the ML training module of the machine learning computer, spatial-temporal features from the second set of bitplanes;
creating, by the ML training module of the machine learning computer, a training feature set; and
performing, by the ML training module of the machine learning computer, a second machine learning model on the training feature set to generate the computational model.

10. The method of claim 9, wherein an output of the second machine learning model is the physiological state.

11. A computer system comprising a smart device, wherein the smart device is configured to:
capture, by camera of the smart device, a plurality of images of a body part of an existing or potential insurance policy holder;
determine, by an application program running on the smart device, a plurality of hemoglobin concentration (HC) changes based on the plurality of images;
determine, by the application program, a set of bitplanes of the plurality of images that represent the plurality of hemoglobin concentration (HC) changes of the existing or potential insurance policy holder;
extract, by the application program, a value for a vital sign from the plurality of HC changes;
build, by the application program, a feature set comprising the plurality of HC changes;
perform, by the application program, a trained machine learning model comprising a computational model on the feature set to obtain an output data set comprising a physiological state for the vital sign;
generate, by the application program, an underwriting package comprising the value for the vital sign and the physiological state for the vital sign; and
send, by the application program, the underwriting package to a central computer.

12. The computer system of claim 11, wherein the application program of the smart device is further configured to:
receive, from the central computer, an insurance policy premium that was determined based at least in part on the underwriting package.

13. The computer system of claim 12, wherein the application program of the smart device is further configured to:
prior to capturing, send a notification message to the central computer; and
prior to capturing and after sending the notification message, receive from the central computer, a request to scan the body part of the existing or potential insurance policy holder.

14. The computer system of claim 13, wherein a time period between when the notification message is sent and the underwriting package is sent is near real-time.

15. The computer system of claim 11, wherein the application program of the smart device is further configured to:
determine a classification for the physiological state for the vital sign, wherein the underwriting package includes the classification.

16. The computer system of claim 15, wherein the classification is normal, elevated, or severe.

17. The computer system of claim 11, wherein the application program of the smart device is further configured to:
receive, from a machine learning computer, the trained machine learning model.

18. The computer system of claim 11, wherein the trained machine learning model is a K-means clustering model or a neural network model.

19. The computer system of claim 11, further comprising a machine learning computer, wherein the machine learning computer is configured to:
receive, from the smart device, the plurality of images;
determine, by a ML training module of the machine learning computer, a second plurality of hemoglobin concentration (HC) changes based on the plurality of images;
determine, by the ML training module of the machine learning computer, a second set of bitplanes of the plurality of images that represent the second plurality of hemoglobin concentration (HC) changes;
extract, by the ML training module of the machine learning computer, spatial-temporal features from the second set of bitplanes;
create, by the ML training module of the machine learning computer, a training feature set based on the spatial-temporal features; and
perform, by the ML training module of the machine learning computer, a second machine learning model on the training feature set to generate the computational model.

20. The computer system of claim 19, wherein an output of the second machine learning model is the physiological state.
